(19) United States
(12) Patent Application Publication
(10) Pub. No.: US 2015/0276485 A1
(43) Pub. Date: Oct. 1, 2015

(54) SYSTEM AND METHOD FOR SORTING FAN DECK COLORS

(71) Applicant: AXALTA COATING SYSTEMS IP CO., LLC., Wilmington, DE (US)

(72) Inventor: David H. ALMAN, Royal Oak, MI (US)

(21) Appl. No.: 14/228,490

(22) Filed: Mar. 28, 2014

(51) Int. Cl. G01J 3/46; G01J 3/52

(52) U.S. Cl. CPC G01J 3/463; G01J 3/52

(57) ABSTRACT

A system and method is provided for chromatically sorting a plurality of colors into fan decks. The method comprises receiving color identifier data and color measurement data in at least one illumination and viewing geometry for the plurality of colors to be sorted into the fan decks and clustering the colors in a processor. The colors are then assigned to the fan decks based on the similarity of the colors as determined by the clustering.

### TECHNICAL FIELD

Embodiments of the subject matter described herein relate generally to color sorting and, more particularly, to a system and method for sorting color chips to produce color sorted fan decks.

### BACKGROUND

Visualization and selection of colors plays an important role in many applications. For example, paint suppliers must provide thousands of colors to cover the range of global OEM manufacturers' colors for all current and recent model vehicles. Providing this large number of different colors as factory package products adds complexity to paint manufacture and increases inventory costs. Consequently, paint suppliers provide a mixing machine system consisting of typically 50 to 100 ingredients (e.g., single pigment tints, binders, solvents, additives) with mixture formulas that match the range of vehicle colors. The mixing machine may reside at a repair facility (body shop) or a paint distributor and allows a user to obtain the desired color by dispensing the proper amounts of a color formula consisting of typically 4 to 10 ingredients. The color mixture formulas are maintained in a database and are distributed to customers via computer software by download or direct connection to internet databases.

Identification of the best mix formula is complicated by color variation in vehicle production. For example, a particular color might appear on three vehicle models, produced in two assembly plants with various application equipment, using paint from two OEM paint suppliers, and over a lifetime of five model years. These sources of variation result in significant color variation over the population of vehicles with that nominal color. The repair paint supplier provides color formula alternates matched to subsets of the color population so that a close match is available for any vehicle that needs repair. Each of the alternate color formulas can be represented by a color chip in the fan deck which enables the user to select the best matching formula by visual comparison to the vehicle.

So the complete mixing machine system comprises paint ingredients, a database of paint mixture formulas for vehicle colors and color alternates, distribution of color formulas via computer software with internet connection to the formula database, and means to identify the vehicle color to be repaired using manufacturer code, portable spectrophotometer or fan decks. Regardless of the means used to identify the color formula, the user will typically verify the selection before expending time and materials to dispense the repair paint. The verification step is done by visually comparing the fan deck chip representing the paint mix formula to the vehicle.

There are several methods for identifying the correct mix formula for a repair. Manufacturer color code information is on a tag on the vehicle allowing formula retrieval by reference to the manufacturer color code. Alternatively, a portable spectrophotometer may be used to measure the color of the vehicle. Software then provides the closest matching formula in a formula database. Alternatively, paint suppliers provide collections of color samples (color chips) that allow the customer to select the best matching color by visual comparison to the vehicle. The color collection is typically in the form of fan decks that usually comprise an easy-to-view stack of color chips on rings that allow the plurality of chips to fan for easy viewing. The collection will have many fan decks to cover thousands of the more popular manufacturer colors with each fan deck containing in the order of 100 colors.

The fan decks may be organized by manufacturer and manufacturer color code or by color regardless of manufacturer. The latter are referred to as chromatically sorted fan decks and provide more formula alternatives and complete visual color retrieval. Thus, a fan deck containing the various shades of, for example, metallic red, gives the user many more choices. However, the organization of thousands of colors into many fan decks is difficult when done by visual sorting. In one specific example, a fan deck was comprised 1562 solid, 5641 effect, and 111 tri-coat colors arranged by manufacturer and totaled 7344 colors. These colors are multivariate and may be characterized by color travel and sparkle. While these colors may be grouped by color similarity, there is no simple way to determine the sequence of chips within a given fan deck. This is further complicated by the size limitations of individual decks; i.e. the physical dimensions of a deck may only accommodate 80 color chips. Thus, these thousands of chips have to be organized into fan decks, each containing no more than about 80 chips and wherein neighboring colors appear in the same deck and occupy neighboring positions in each deck.

Thus, it would be desirable to provide a system and method for organizing chromatically sorted fan decks. It would also be desirable to provide a system and method for organizing a chromatically sorted fan deck wherein (1) color chip neighbors appear in the same fan deck, (2) color chip neighbors appear near each other in the same fan deck, and (3) each fan deck is properly sequenced with respect to other fan decks.

Still further, it would be desirable to provide a system and method for organizing chromatically sorted fan decks that offer easy and intuitive navigation for the selection of an appropriate fan deck containing colors near a vehicle color.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A method is provided for chromatically sorting a plurality of colors into fan decks. The method comprises receiving color identifier data and color measurement data in at least one illumination and viewing geometry for the plurality of colors to be sorted into the fan decks and clustering the colors in a processor. The colors are then assigned to the fan decks based on the similarity of the colors as determined by the clustering.

A system for chromatically sorting colors into a fan deck is also provided wherein each fan deck is comprised of a plurality of color chips. The system comprises a first source of chip formula data, a second source of color data, and a processor coupled to the first and second sources and configured to (a) cluster colors within a subset of colors; and (b) order colors within a cluster.

Further, a chromatically sorted fan deck is produced in accordance with the steps of receiving color identifier data and color measurement data, in at least one illumination and viewing geometry, for a set of colors to be sorted into the fan decks determining which of a solid, effect or tri-coat subset each color falls into, clustering in a processor the colors within each subset, determining in the processor if the subset is chromatic or neutral, ordering the cluster by hue if chromatic and by lightness if neutral, selecting a single cluster, and sequencing the colors within the single cluster with the processor.

Furthermore, other desirable features and characteristics of the system and method will become apparent from the following detailed description and the appended claims, taken in conjunction with the accompanying drawings and the preceding background.

### BRIEF DESCRIPTION OF THE DRAWINGS

Embodiments of the subject matter will hereinafter be described in conjunction with the following figures, wherein like numerals denote like elements, and:

FIG. 1 is a flow chart illustrating a method for organizing a chromatically sorted fan deck such that color chip neighbors are properly sequenced in the same fan deck, color chip neighbors appear near each other in the same fan deck, and each fan deck is properly sequenced with respect to other fan decks, in accordance with an exemplary embodiment;

FIG. 2 is a block diagram illustrating a system for carrying out the process shown and described in connection with FIG. 1;

FIG. 3 is a dendrogram describing the re-clustering of 17 colors in a tri-coat chromatic cluster into five distinct sub-clusters in accordance with a first example;

FIG. 4 is a 3D scatter plot associated with the example shown in FIG. 3;

FIG. 5 is a matrix plot of selected data dimensions by sequence order and sub-cluster grouping for a tri-coat chromatic cluster;

FIG. 6 is a dendrogram describing the re-clustering of a red effect cluster leading to 3 sub-clusters in accordance with another example;

FIG. 7 is a 3D scatter plot of the example shown in FIG. 6; and

FIG. 8 is a matrix plot of selected data dimensions by sequence order and sub-cluster grouping for a red effect cluster.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements, additional intervening elements, devices, features, or components may be present in an embodiment of the depicted subject matter. In addition, certain terminology may also be used in the following description for the purpose of reference only, and thus are not intended to be limiting.

The following detailed description is merely illustrative in nature and is not intended to limit the embodiments of the subject matter or the application and uses of such embodiments. Any implementation described herein as exemplary is not necessarily to be construed as preferred or advantageous over other implementations. Furthermore, there is no intention to be bound by any expressed or implied theory presented in the preceding technical field, background, brief summary, or the following detailed description.

Techniques and technologies may be described herein in terms of functional and/or logical block components and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to graphics and image processing, touchscreen displays, and other functional aspects of certain systems and subsystems (and the individual operating components thereof) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

As suggested earlier, a paint supplier maintains a color formula database including manufacturer, mixing machine system, paint formula, color standard and fan deck chip identifiers, formula ingredients and amounts for a standard paint volume (typically 1 gallon or 1 liter), and property data. Property data includes measured or calculated properties of the wet paint (e.g., density, volatile organic content) or the dry paint sample or chip (color, gloss). The most important properties for chromatic sorting are color type (e.g., solid, effect, tri-coat), color and sparkle data.

Effect colors contain large, flat platelet pigments (typically aluminum or pearlescent flake pigments) that impart a directional variation in color (color travel) and sparkle or glints of high reflectance from the flakes. Tri-coats are usually a solid color basecoat layer with a transparent flake-containing mid-coat layer and a clear coat top layer and have unique color travel appearance.

Color data is obtained by measuring the paint sample or chip using a color spectrophotometer with at least one illumination and viewing geometry, e.g. illumination at 45 degrees and viewing at 0 degrees relative to a direction perpendicular to the sample surface. Colors containing metallic or other flake pigments have color variation with directions of illumination and viewing. This color variation or color travel is characterized by color measurements at multiple illumination and viewing geometries and the measurement geometries are described by the aspecular angle of the measurement geometry, i.e., the angle between the viewing and specular reflection directions (see American Society for Testing and Materials (ASTM), Standard Practice for Specifying the Geometry of Multiangle Spectrophotometers, Technical Report ASTM E2194.01 (2011)). For example, the Acquire Plus EFX™ manufactured by Byk-Gardner GMBH provides color measurements at 15, 45 and 110 aspecular angles to characterize color travel of colors. Color measurements are made as spectral reflectance measurements at each measurement geometry, and CIE colorimetry (Commission Internationale De L'Éclairage (CIE), Colorimetry, 3^{rd} ed., CIE 015:2004, CIE Central Bureau, Vienna, 2004) is used to compute XYZ tristimulus values for daylight Illuminant D65 and the 1964 standard observer; however, other Illuminants and observers are possible. The tristimulus values are transformed to CIELAB (CIE 1976 L* a* b* color space) at aspecular directions 15, 45 and 110 for a total of 9 color data dimensions, which is the data provided in the color formula database. Since solid colors show little color travel variation with direction, L* a* b* values at aspecular angle 45 are used to define solid colors. For effect and tri-coat colors, L* a* b* at aspecular angles 15, 45 and 110 are used to define color. CIELAB L* a* b* values are used in a preferred embodiment to provide a uniform color space in which equal differences in any dimension produce approximately equal visual magnitude. It should be noted, however, that any color coordinates derived from CIE XYZ tristimulus measurements or any other numerical color specification system could be used for color description and chromatic sorting.

The Byk Acquire plus EFX™ also provides measurements of Sparkle Grade at aspecular angles 15 and 45 (Sg15, Sg45) that correspond to the perceived strength of sparkle appearance in those directions. These sparkle data values are likewise included in the color formula database. Solid colors are defined by a set of 3 color dimensions (i.e. L*45, a*45, and b*45) and effect or tri-coat colors are defined by 11 color and sparkle dimensions (i.e. L*15, a*15, b*15, L*45, a*45, b*45, L*110, a*110, b*110, Sg15, Sg45). It is to be noted, however, that the color and appearance data set could be extended to different or additional directions, other color coordinate systems, or other appearance measurements.

Typically, a fan deck is developed for a specific mixing machine system. Data representing the color formulas and color chips to be included in the fan decks are extracted from the color formula database. Each observation includes manufacturer, paint formula, color chip, color type identifiers, and color and sparkle measurements. In addition, CIELAB chroma (C*) and hue angles (h) at aspecular angles 15, 45, 110 are determined for use during the chromatic sorting method. In a preferred embodiment, this chip data is split into different subsets for solid, effect, and tri-coat colors; however various other sub-divisions of the data are possible.

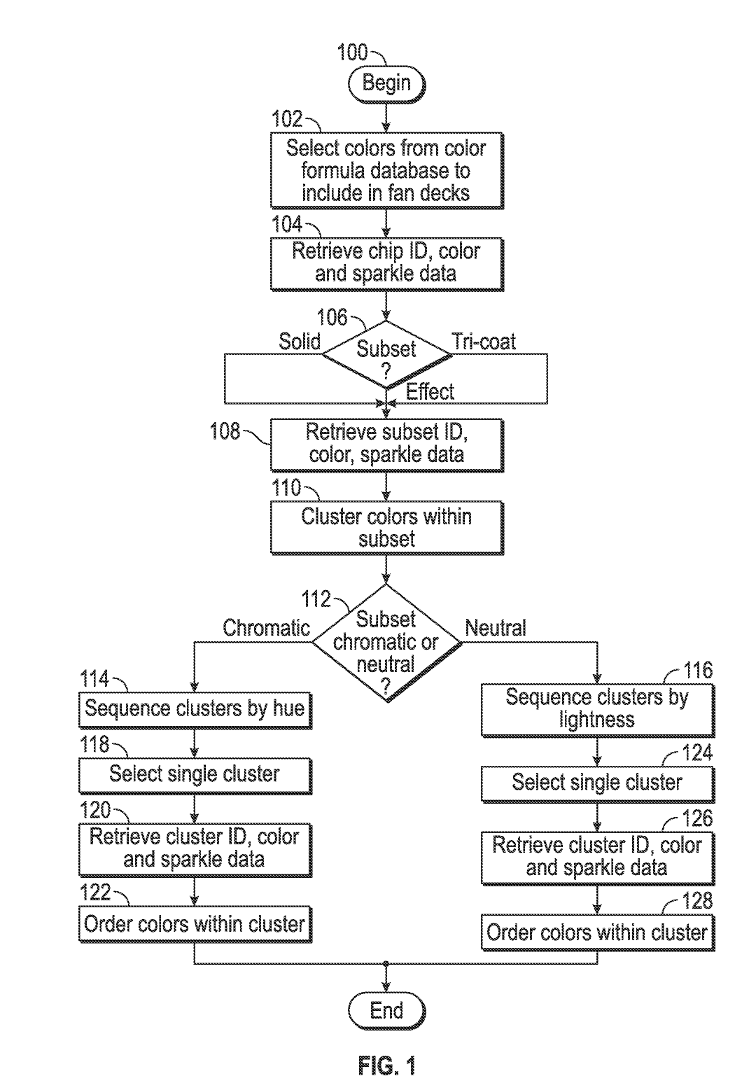

FIG. 1 is a flow chart 100 illustrating a method for organizing a chromatically sorted fan deck such that color chip neighbors are properly sequenced in the same fan deck, color chip neighbors appear near each other in the same fan deck, and each fan deck is properly sequenced with respect to other fan decks, in accordance with an exemplary embodiment. In STEP 102, the colors that are to be included in one or more fan decks are selected from a color formula database, and the color data associated with each color (i.e. chip identification data, color data, and sparkle data, as above described) is retrieved from the database (STEP 104). In STEP 106, a determination is made as to whether a selected color belongs to a solid, an effect, or a tri-coat subset. Chip identification data, color data, and sparkle data for the subset determined in STEP 106 is then retrieved (STEP 108). It should be understood that while chip identification data, color data, and sparkle data have been selected in an embodiment, other and/or additional parameters may be used.

In STEP 110, the color and sparkle data is used as a multivariate data space to define color observations using cluster analysis (or simply clustering); i.e., grouping a set of objects in such a way that objects in the same group (i.e., a cluster) are more similar (in some way or another) to each other than to those in other groups (clusters). Clustering is a common technique for statistical data analysis in many fields, including machine learning, pattern recognition, image analysis, information retrieval, and bioinformatics (see Alvin C. Rencher, William F. Christensen, Methods of Multivariate Analysis, 3^{rd} ed., John Wiley and Sons, Hoboken, N.J., 2012).

Cluster analysis does not comprise one specific algorithm, but is achieved using various algorithms that differ significantly in their notion of what constitutes a cluster and how to efficiently find them. Popular notions of clusters include groups with small distances between cluster members, dense areas of the data space, and intervals or particular statistical distributions. Clustering can therefore be considered a multi-objective optimization problem. The appropriate clustering algorithm and parameter settings (including values such as the distance function to use, a density threshold, or the number of expected clusters) depend on the data set and intended use of the results. Cluster analysis is not an automatic task, but an iterative process of knowledge discovery or interactive multi-objective optimization that involves trial and failure. It is often necessary to modify data preprocessing and model parameters until the result achieves the desired properties.

There are many clustering algorithms that have in common a group of data objects, and there are different cluster models, and for each of these cluster models again different algorithms. The notion of a cluster, as found by different algorithms, varies significantly in its properties. Typical cluster models include connectivity models (e.g., where hierarchical clustering builds models based on distance connectivity); centroid models (e.g., the k-means algorithm where each cluster is represented by a single mean vector); distribution models where clusters are modeled using statistical distributions, such as multivariate normal distributions; and others.

A “clustering” is essentially a set of such clusters, usually containing all objects in the data set. Additionally, it may specify the relationship of the clusters to each other; e.g., a hierarchy of clusters embedded in each other. Clusterings can be roughly distinguished as, for example, hard clustering where each object either belongs to a cluster or not; soft or fuzzy clustering where each object belongs to each cluster to a certain degree; strict partitioning where each object belongs to exactly one cluster; strict partitioning clustering with outliers where objects can also belong to no cluster and are considered outliers; overlapping clustering; hierarchical clustering where objects that belong to a child cluster also belong to the parent cluster; subspace clustering where clusters are not expected to overlap; and others.

Clustering algorithms can be categorized based on their cluster model, and there are possibly over 100 published clustering algorithms. The most appropriate clustering algorithm for a particular problem often needs to be chosen experimentally, unless there is a mathematical reason to prefer one cluster model over another.

Connectivity based clustering, also known as hierarchical clustering, is based on the core idea of objects being more related to nearby objects than to objects farther away. These algorithms connect “objects” to form “clusters” based on their distance. A cluster can be described largely by the maximum distance needed to connect parts of the cluster. At different distances, different clusters will form, which can be represented using a dendrogram. These algorithms do not provide a single partitioning of the data set, but instead provide an extensive hierarchy of clusters that merge with each other at certain distances. In a dendrogram, the y-axis marks the distance at which the clusters merge, while the objects are placed along the x-axis such that the clusters don't mix.

Connectivity based clustering is a whole family of methods that differ by the way distances are computed. The methods associated with connectivity based clustering will typically not produce a unique partitioning of the data set, but a hierarchy from which a user still needs to choose appropriate clusters.

Hierarchical clustering begins by calculating all inter-point distances. Distances can use Euclidean, city block, Euclidean squared, or other distance metric. The closest points or clusters are combined in sequence from all points are clusters to all points in one cluster. That is if there are 100 points, there will sequence levels with 99, 98, 97, . . . 3, 2, 1 cluster groups. A linkage rule is used to decide which point or cluster is “closest” to a prior point or cluster at each step. The user reviews the results and selects what number of clusters best separates points into useful groups. For the fan deck problem, key design parameters are the maximum and minimum number of colors within a fan deck. For example, the thickness of the color chips and the size of the fan deck ring or post may impose an upper limit on the number of chips per fan deck. Clusters with color count larger than the deck maximum can form a new data set which can be clustered again to form smaller clusters with counts less than the deck maximum. Clusters with very small counts can be appended to neighboring clusters.

In centroid-based clustering, clusters are represented by a central vector, which may not necessarily be a member of the data set. When the number of clusters is fixed to k, k-means clustering gives a formal definition as an optimization of finding the k cluster centers and assigning the objects to the nearest cluster center such that the squared distances from the cluster centers are minimized.

A common approach is to search only for approximate solutions. One well known approximative method is Lloyd's algorithm, often actually referred to as the “k-means algorithm”. It does however only find a local optimum and is commonly run multiple times with different random initializations.

When using k-means clustering, the user chooses the number of desired clusters (k). As before, data dimensions can be selected or scaled before clustering. In an initialization step the user assigns observations to the k clusters by a random or other process. The algorithm iteratively assigns points to the cluster with nearest distance to a cluster centroid, then updates the cluster centroids and repeats until no more observations change between clusters. This clustering is non-hierarchical in that an observation can add to a cluster and at a later iteration move to a different cluster. There is no control over the count within a cluster. Thus, if a cluster count exceeds the maximum, then the cluster is taken as a subset and clustering is repeated to form smaller clusters.

Hierarchical or k-means clustering algorithms are used to assign observations to clusters based on the similarity of their multivariate color points. Distances between data points will depend on the scaling and selection of the data dimensions. A user may choose to use all dimensions or subsets considering that dimensions may be correlated and/or have different magnitudes. The use of uniform color space coordinates may be advantageous since the dimensions have approximately equal visual magnitudes. Alternatively a user might standardize the dimensions or apply some other dimension scaling. (For a more detailed description of clustering, the interested reader is referred to Alvin C. Rencher, William F. Christensen, Methods of Multivariate Analysis, 3^{rd} ed., John Wiley and Sons, Hoboken, N.J., 2012.)

In the instant case, the result of STEP 110 of the method 100 is the assignment of colors to deck clusters based on color/sparkle similarity, and all deck clusters have counts within the fan deck capacity maximum.

Each color assigned to a cluster is assigned to neutral or chromatic groups in STEP 112. There can be in the order of one-hundred clusters. Neutral colors include white, black, gray, silver metallic, gray metallic, black metallic and other colors with low chroma. Chromatic colors include red, yellow, green, blue and intermediate hues at higher chroma. Neutral and chromatic groups provide an intuitive segregation into less and more colorful groups that is helpful in navigating to the group of decks. However, the selection of groups is arbitrary, and other groups of decks are possible. The deck clusters are assigned to the group based on comparison of the mean chroma of the cluster to a chroma tolerance. For example, if the mean chroma of a cluster is greater than ten, the cluster is assigned to the chromatic group. If less than ten, it is assign to the neutral group.

In STEP 114, the chromatic deck clusters are placed in a sequential order by hue for placement in a cabinet or other device that holds the decks. The goal here is to provide easy and intuitive navigation to the desired deck clusters. The selection of a sequence rule is arbitrary. For neutral deck clusters, a sequence based on lightness of the cluster means from light-to-dark may be chosen; e.g., white-to-black for solid colors and silver-to-black metallic for effect colors. For chromatic deck clusters, a sequence based on hue angle running from bluish red to red, yellow, green, blue, and purple may be chosen. This provides a natural progression based on the hue circle; i.e. a visually intuitive organization. In a similar fashion, the neutral deck clusters are placed in sequential order by lightness for placement in a cabinet or other device that holds the decks (STEP 116).

A single cluster is selected in STEP 118. The cluster identification, color, and sparkle data for the chips in the selected cluster is retrieved (STEP 120), and the colors within the cluster are sequenced (STEP 122). This process is repeated for all clusters sequenced in STEP 116; i.e. sequencing neutral colors by lightness. That is, STEPS 124, 126, and 128 are substantially equivalent to STEPS 118, 120, and 122, respectively, for sequencing colors by hue.

The observations within a deck cluster are sequenced to keep similar colors as near neighbors. Since the observations vary over 3 to 11 dimensions, there will generally be no single dimension that sequences the observations and keeps neighbors in adjacent positions in the sequence. The distributions of observations (a multi-variate data cloud) may be compact or elongated, may have single or multiple neighbor groups, and may have isolated out-lier observations. The distributions can be viewed as single or multiple hyper-sphere or hyper-oblong shapes. Hierarchical or k-means clustering, as described above, is used in conjunction with multi-variate graphical visualization to select the number of within-deck clusters that groups observations into useful neighbor clusters. These neighbor clusters are sequenced by an arbitrary sequence rule. For example, the neighbor clusters of a chromatic deck might be ordered by hue angle.

As stated above, the observations within each neighbor cluster must be sequenced. If the neighbor cluster has a hyper-oblong shape, there is a dimension along the longest direction of the hyper-obloid, although this dimension will generally not be one of the original color or sparkle dimensions. The principal direction of variation can be found by applying principal component analysis (PCA) to the multi-variate observation data to transform the data to new orthogonal dimensions with successively smaller variances (see Rencher et al).

PCA is a statistical procedure that uses orthogonal transformation to convert a set of observations of possibly correlated variables into a set of values of linearly uncorrelated variables called principal components. The number of principal components is less than or equal to the number of original variables. This transformation is defined in such a way that the first principal component has the largest possible variance (that is, accounts for as much of the variability in the data as possible), and each succeeding component in turn has the highest variance possible under the constraint that it is orthogonal to (i.e., uncorrelated with) the preceding components.

PCA is the simplest of the true eigenvector-based multivariate analyses. Often, its operation can be thought of as revealing the internal structure of the data in a way that best explains the variance in the data. If a multivariate dataset is visualized as a set of coordinates in a high-dimensional data space (1 axis per variable), PCA can supply the user with a lower-dimensional picture, a projection or “shadow” of this object when viewed from its (in some sense) most informative viewpoint. This is done by using only the first few principal components so that the dimensionality of the transformed data is reduced.

PCA is mathematically defined as an orthogonal linear transformation that transforms the data to a new coordinate system such that the greatest variance by some projection of the data comes to lie on the first coordinate (called the first principal component), the second greatest variance on the second coordinate, and so on.

In the instant case, the first vector dimension contains the maximum variance of all linear sequences of the data. Each observation has a projection score on the first dimension. The rank order of the scores provides the sequence of observations along the principal vector. In a worst case scenario, all of the transformed dimensions have equal variance, the data cloud is a hyper-sphere, and there is no principal linear direction and sequence. More generally the neighbor cluster will have some principal direction of variation that is useful for sequencing.

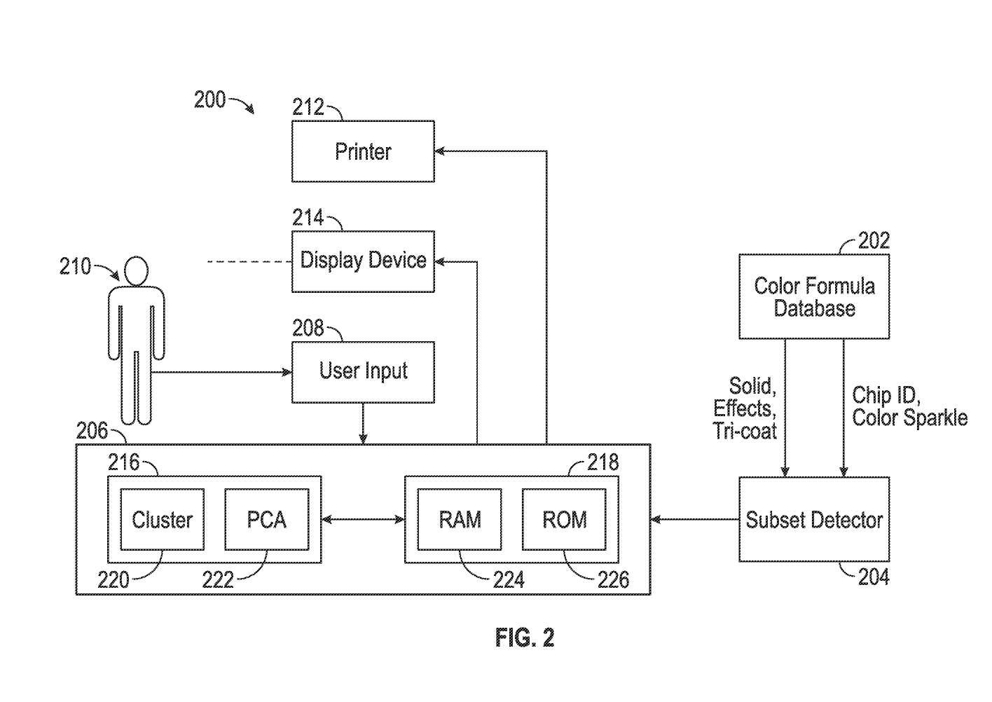

FIG. 2 is a block diagram of a system 200 suitable for carrying out the process described above in connection with FIG. 1. The colors that are to be included in one or more fan decks are selected from a color formula database 202 and supplied to subset detector 204 where the chip identification data, color data, and sparkle data are retrieved. A processor 206 receives a first input from detector 204 and a second input from a user input device 208 (e.g. a keyboard, cursor control device, etc.) from user 210. Processor 206 provides outputs to output devices that may comprise one or more printers 212, one or more display systems 214, and the like. Processor 206 includes a processing module 216 and a memory module 218. Processing module includes clustering software 220 and PCA software 222 of the type mentioned above.

Processor 206 may be implemented or realized with a general purpose processor, a content addressable memory, a digital signal processor, an application specific integrated circuit, a field programmable gate array, any suitable programmable logic device, discrete gate or transistor logic, discrete hardware components, or any combination designed to perform the functions described herein. A processor device may be realized as a microprocessor, a controller, a microcontroller, or a state machine. Moreover, a processor device may be implemented as a combination of computing devices, e.g., a combination of a digital signal processor and a microprocessor, a plurality of microprocessors, one or more microprocessors in conjunction with a digital signal processor core, or any other such configuration. In the depicted embodiment, the processor 206 includes a memory 218 comprised of, for example, RAM (random access memory) 224, and ROM (read-only memory) 226. The program instructions that control the processor 206 may be stored in either or both the RAM 224 and the ROM 226. For example, the operating system software may be stored in the ROM 226, whereas various operating mode software routines and various operational parameters may be stored in the RAM 224. The software executing the exemplary embodiment may be stored in either the ROM 226 or the RAM 224. However, for clarity, cluster software 220 and PCA software 222 described above are shown separately.

The memory 218 may be realized as RAM, ROM, flash memory, EPROM memory, EEPROM memory, registers, a hard disk, a removable disk, a CD-ROM, or any other form of storage medium known in the art. In this regard, the memory 218 can be coupled such that the processor 206 can be read information from, and write information to, the memory 218. In the alternative, the processor 206 and the memory 218 may reside in an ASIC. In practice, a functional or logical module/component of the system 200 might be realized using program code that is maintained in the memory 218. For example, the memory 218 can be used to store data utilized to support the operation of the display system 200.

The display element 214 is used to display various images and data, in both a graphical and a textual format, and to supply visual feedback to the user 210 in response to the user input commands supplied by the user 210 to the user input device 208. It will be appreciated that the display element 214 may be any one of numerous known displays suitable for rendering image and/or text data in a format viewable by the user 210. Non-limiting examples of such displays include various cathode ray tube (CRT) displays, and various flat panel displays such as, various types of LCD (liquid crystal display), OLED, and TFT (thin film transistor) displays. The display element 214 may additionally be based on a panel mounted display, a HUD projection, or any known technology. In an exemplary embodiment, the display element 214 includes a panel display, and the display element 214 is suitably configured to receive image rendering display commands from the processor 206.

The user input device 208 is in operable communication with the processor architecture 206 and is configured to receive input from a user 210 and, in response to the user input, supply command signals to the processor architecture 206. The user input 208 may be any one, or combination, of various known user interface devices including, but not limited to, a cursor control device (CCD), such as a mouse, a trackball, or joystick, one or more buttons, switches, or knobs. In a preferred embodiment, the user input 208 includes the CCD and a keyboard. The user 210 manipulates the user input 208 to, among other things, move cursor symbols that might be rendered at various times on the display element 214 or activate printer 212, and the user 210 may manipulate the keyboard to, among other things, input textual data and print.

As stated previously, FIG. 2 is a block diagram of a system for organizing a chromatically sorted fan deck such that color chip neighbors are properly sequenced in the same fan deck, color chip neighbors appear near each other in the same fan deck, and each fan deck is properly sequenced with respect to other fan decks, in accordance with an exemplary embodiment. The colors that are to be included in one or more fan decks are selected from a color formula database 202 (solid, and/or effect, and/or tri-coat colors), and the color data associated with each color (i.e. chip identification data, color data, and sparkle data, as above described) is retrieved and provided to subset detector 204, which determines if a selected color belongs to a solid, an effect, or a tri-coat subset. Chip identification data, color data, and sparkle data, for the identified subset is then provided to processor 206. The reader is once again reminded that while chip identification data, color data, and sparkle data have been provided in an embodiment, other and/or additional parameters may be used. The above described cluster analysis is performed via the cluster software 220 in processor 206 using one or more of the techniques described above. This results in the assignment of colors to deck clusters based on color/sparkle similarity, and all deck clusters have counts within the fan deck capacity maximum.

The software then assigns each color to neutral or chromatic groups. Neutral and chromatic groups provide an intuitive segregation into less and more colorful groups that is helpful in navigating to the group of decks. However, the selection of groups is arbitrary and other groups of decks are possible. The processor then places the chromatic deck clusters in sequential order by hue. The goal here is to provide easy and intuitive navigation to the desired deck clusters For neutral deck clusters, a sequence based on lightness of the cluster (i.e. light to dark) may be chosen; e.g., white- to-black for solid colors and silver-to-black metallic for effect colors. For chromatic deck clusters, a sequence based on hue angle running from bluish-red to red, yellow, green, blue, and purple may be chosen.

After a single cluster is selected, the cluster identification, color, and sparkle data for the chips in the selected cluster is retrieved from memory 218, and the colors within the cluster are ordered. This process is repeated for all clusters.

The observations within each neighbor cluster must be sequenced. If the neighbor cluster has a hyper-oblong shape there is a dimension along the longest direction of the hyper-obloid, although this dimension will generally not be one of the original color or sparkle dimensions. The principal direction of variation can be found by utilizing the PCA software 222 as described above.

In an exemplary embodiment, a chromatically sorted fan deck was investigated using color formula and color chip data for 6192 color chips retrieved from a master color formula database (STEP 102 in FIG. 1) and comprised color chip identification, color formula identification, vehicle manufacturer color identification, coatings type (basecoat/clear coat or tri-coat system), color type (solid, metallic, pearlescent), CIELAB L* a* b* data values at a 45 degree aspecular angle for solid colors, at 15, 45, and 110 degree aspecular angles for effect and tri-coat colors, and sparkle grade data values at 15 and 45 degree aspecular angles for effect and tri-coat colors (STEP 104). CIELAB chroma (C*) and hue angle (h) data were calculated for 15, 45, and 110 degree aspecular angles. Coatings type and color type were used to define data subsets (STEP 106) of 1274 solid, 4832 effect, and 86 tri-coat colors.

A target for maximum color chips in a deck was set at 80. This is a soft maximum in that the fan decks can hold more than 80 chips; however, some space is desired for possible additions of future color chips. A data subset was selected (STEP 108) and clustered in multiple trials to find a best compromise between chip count in clusters and separation between clusters. Clustering was done using hierarchical clustering with Euclidean distance and Ward's linkage algorithms, but with varying selection of data values to include in the clustering (STEP 110).

Solid color clustering used L*45, a*45, b*45 data values. A result with 26 clusters varying from 14 to 117 colors per cluster was selected. Six of the clusters (three red and three white) had counts over 80 and ranging from 89 to 117. The three red clusters were combined and clustered again resulting in six clusters with counts from 27 to 67. Similarly, three white clusters were combined and clustered again resulting in six clusters with counts from 9 to 80. The combined results were 32 solid color clusters with a maximum of 80 colors per cluster.

Effect color clustering used L*45, a*45, b*45 data values and a result with 70 clusters, varying from 16 to 170 colors per cluster, was selected. A compromise for maximum chips per cluster was made to avoid having too many decks. Up to 85 chips were allowed in the effect decks and there were 18 clusters with more than 85 colors. The larger clusters were clustered again but using L*15/2, a*15/2, b*15/2, L*45, a*45, b*45, L*110, a*110, b*110, Sg15, and Sg45 data values. The set of dimensions was increased to aid in separating neighbor colors into clusters. However, L*15, a*15, b*15 have larger magnitudes and variances than the other dimensions and would tend to dominate the Euclidean distances between points. These dimensions were divided by 2 as a simple means to reduce their influence on the clustering results. In most cases the larger clusters were re-clustered into two clusters with counts less than 85. In a few cases there were more clusters and for some of these, a small cluster was forced to join the closest larger cluster. In total there are 91 effect clusters with maximum 85 colors per cluster.

Tri-coat color clustering used L*15, a*15, b*15, L*45, a*45, b*45 data values and a result with five clusters with counts of 4, 5, 8, 29, and 40 was selected. The three smallest clusters were chromatic and the two largest were white. The three smallest clusters were combined to yield three tri-coat clusters with 17 to 40 colors.

The clusters in solid (26) and effect (91) subsets were split into chromatic and neutral groups (STEP 112). With only three clusters, there was no need to sub-divide the tri-coat subset. Solid colors were assigned to the neutral group if mean C*45 for the cluster was less than or equal to 10, otherwise to the chromatic group. Effect colors were assigned to the neutral group if mean C* 15 for the cluster was less than or equal to 10, otherwise to the chromatic group. Neutral clusters were ordered by mean L*45 for both solid and effect subsets (STEP 116). Chromatic clusters were ordered by viewing a scatter plot of mean L*45 by mean h45. Most chromatic clusters follow a sequence by hue angle but with some jumps between different lightness levels. The chromatic order was selected interactively running from low to high hue angle but with some adjustments to keep clusters with similar lightness nearby (STEP 114).

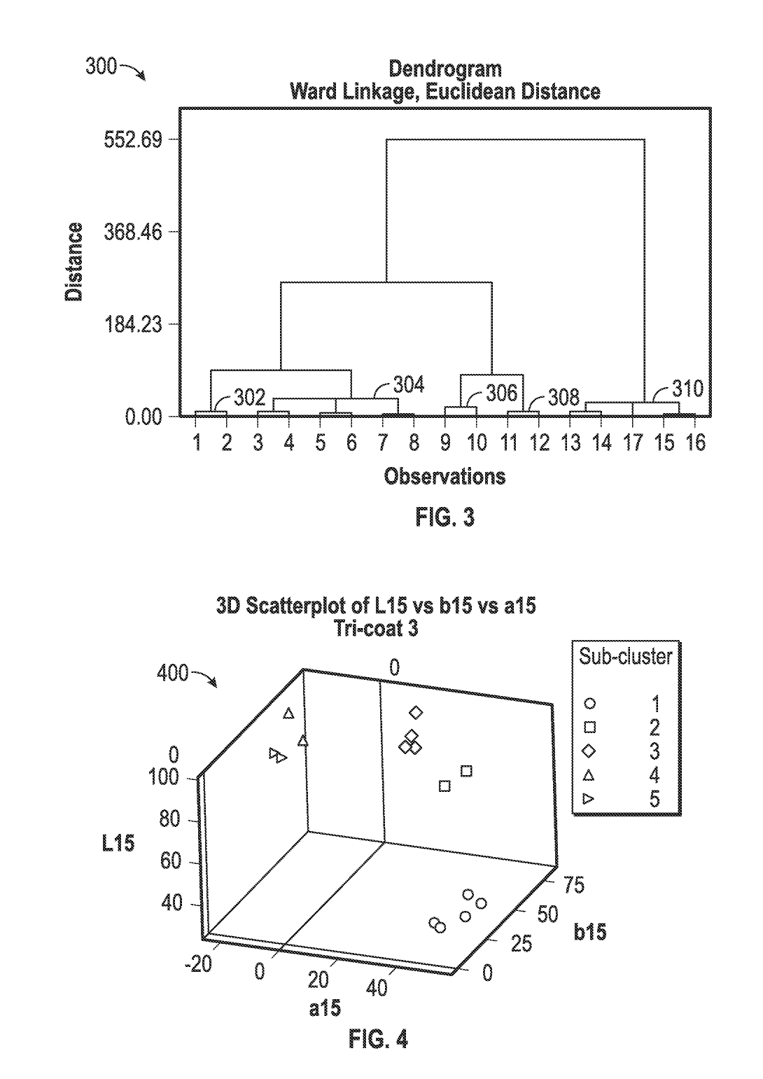

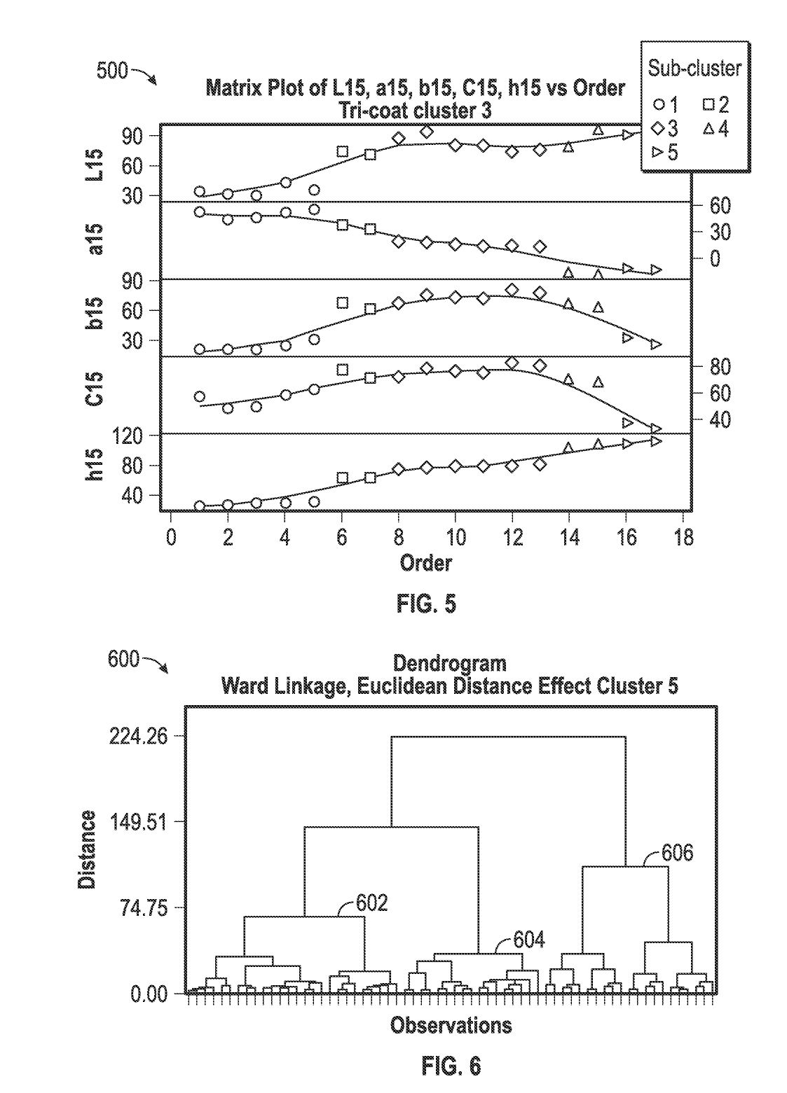

A single cluster was selected from the solid, effect or tri-coat subsets (STEPS 118, 124), the single cluster data was retrieved (STEPS 120, 126), and the colors were ordered within the cluster (STEPS 122, 128). The ordering process depends on the distribution of data values within the single cluster. The first interactive step in ordering colors was to use data visualization and clustering to determine whether there were multiple sub-clusters of color neighbors within the “single cluster.” For example, re-clustering 17 colors in a tri-coat chromatic cluster shows five distinct sub-clusters 302, 304, 306, 308, and 310 as shown in the dendrogram 300 (FIG. 3) and 3D scatter plot 400 (FIG. 4) of L*15, a* 15, b* 15. The sub-clusters are widely separated and visualization indicates that hue angle is a good choice for the primary direction of color variation and for ordering the sub-clusters. FIG. 5 is a matrix plot 500 of L*15, a*15, b*15, C*15, and h15 ordered by h15 with sub-cluster grouping. In this case, ordering by h15 brought the sub-cluster neighbors together in the within cluster sequence.

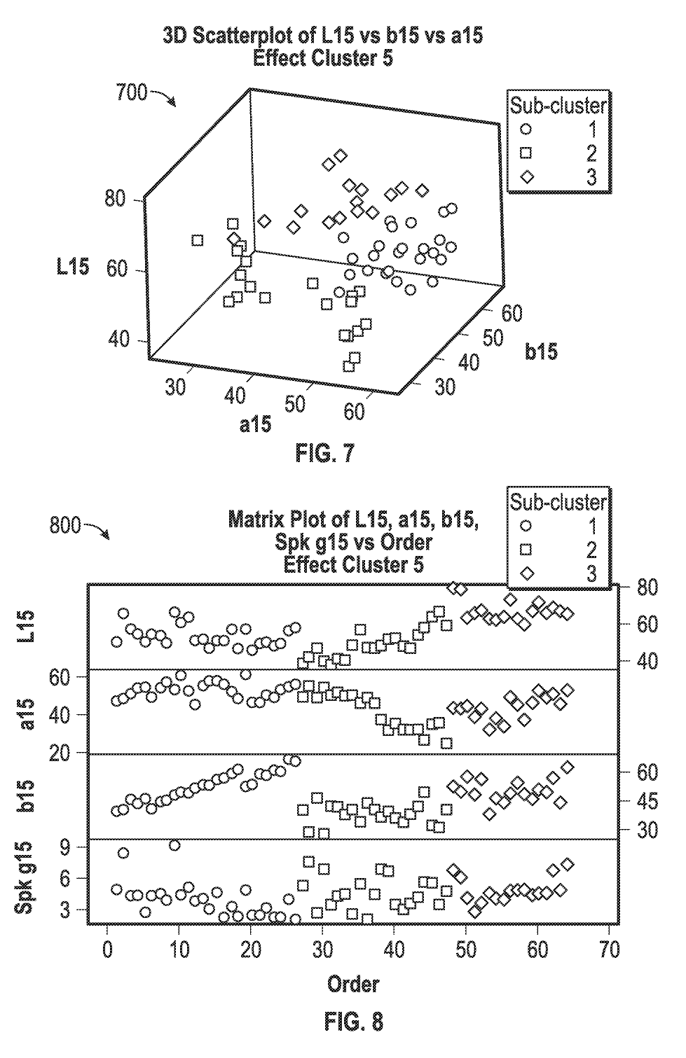

In a second example, red effect cluster 5 was selected for ordering. Re-clustering on L*15/2, a*15/2, b*15/2, L*45, a*45, b*45, L*110, a*110, b*110, Sg15, and Sg45 led to 3 sub-clusters 602, 604, and 606 as shown in dendrogram 600 (FIG. 6) and 3D scatter plot 700 (FIG. 7) of L*15, a*15, b*15. The sub-clusters do not completely separate on the selected dimensions and the sub-cluster “data clouds” appear elongated in some directions. PCA analysis was run on each sub-cluster using the co-variance matrix of L*15/2, a*15/2, b*15/2, L*45, a*45, b*45, L*110, a*110, b*110, Sg15, and Sg45, and the first principal component vector (PC1) was taken as the primary direction of color and sparkle variation of the sub-cluster.

Table I shows the eigenvalue (a measure of variance), proportion of variance in the first component (range 0 to 1) and the first vector in terms of the transformation of the original dimensions. Each data point has score values on the principal component vector. The rank of the data score values was used as the order of data points within a sub-cluster and indicates the order of positions of the data points along the principal component vector. The within sub-cluster orders were combined with the order of the sub-clusters to determine the overall order of the clusters. In other words, the sub-clusters are most important in keeping neighbors nearby, and the orders within sub-cluster are secondary.

TABLE I

| Sub-cluster | 1 | 2 | 3 |
|---|---|---|---|
| EigenValue 1 | 35.72 | 111.16 | 29.07 |
| Proportion 1 | 0.52 | 0.62 | 0.41 |
| Variable | PC1 | PC1 | PC1 |
| L15/2 | −0.15 | 0.33 | −0.08 |
| a15/2 | −0.01 | −0.43 | 0.40 |
| b15/2 | 0.62 | 0.01 | 0.18 |
| L45 | 0.04 | 0.50 | −0.19 |
| a45 | 0.08 | −0.33 | 0.47 |
| b45 | 0.53 | 0.21 | 0.27 |
| L110 | 0.26 | 0.38 | 0.16 |
| a110 | 0.15 | −0.16 | 0.49 |
| b110 | 0.42 | 0.38 | 0.45 |
| Spk g15 | −0.17 | −0.01 | 0.11 |
| Spk g45 | −0.11 | 0.02 | −0.01 |

FIG. 8 is a matrix plot 800 of selected data dimensions by order for effect cluster 5. The ordering brings data neighbors together by sub-cluster and by rank order of principal component scores so that neighbors tend to be close on some data dimensions. For example, the sub-cluster 1 order is strongly influenced by b15, sub-cluster 2 was strongly influenced by L15 and a15 descending, and sub-cluster 3 is weakly influenced by a15 ascending in agreement with the vector components in TABLE I. Sub-cluster 3 has the least dominant order in agreement with the lower proportion in the first principal component as shown in TABLE I.

In general, principal component ordering of the data values will perform better when the first proportion is high indicating the data values lie close to a first vector direction (e.g. sub-cluster 2, 0.62 proportion) and will perform worse when the data values have only a weak first proportion (e.g. sub-cluster 3, 0.41 proportion).

The deck cluster ordering process can be summarized as the following steps: 1) select the data dimensions to be included in the analysis and determine whether re-scaling of dimensions will be helpful in balancing their influence on results; 2) use clustering to identify sub-clusters of neighboring data points; 3) use data graphics to visualize the data distributions and determine the separation and shapes of sub-clusters; 4) select one of the original data dimensions for ordering colors if a dominant dimension is observed; 5) otherwise, perform principal component analysis on each sub-cluster and use the rank order (ascending or descending) of the scores on the first principal component as the order within sub-cluster; and 6) combine sub-cluster order and within sub-cluster order to sequence colors within the deck.

Thus, there has been provided a system and method for organizing chromatically sorted fan decks. There has also been provided a system and method for organizing a chromatically sorted fan deck such that (1) color chip neighbors are in the same fan deck, (2) color chip neighbors appear near each other in the same fan deck, and (3) each fan deck is properly sequenced with respect to other fan decks.

The foregoing exemplary embodiment was described above in the context of a fully functioning computer system; however, those skilled in the art will recognize that the mechanisms of the present invention are capable of being distributed as a program product and, furthermore, that the teachings of the present invention apply to the program product regardless of the particular type of computer-readable media (e.g., floppy disc, hard drive, memory card, optical disc, etc.) employed to carry-out its distribution.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended claims.

1. A method for chromatically sorting colors into fan decks, the method comprising:
receiving color identifier data and color measurement data in at least one illumination and viewing geometry for a set of colors to be sorted into the fan decks;
clustering the colors in a processor; and
assigning the colors to the fan decks based on the similarity of the colors as determined by the clustering.

2. The method of claim 1 further comprising:
receiving sparkle data associated with the colors; and
utilizing the sparkle data during the step of clustering.

3. The method of claim 1 wherein the step of receiving color identifier data and color measurement data comprises receiving color and sparkle data and chip identification data.

4. The method of claim 3 further comprising determining in the processor that a color falls within one of a solid, an effect, and a tri-coat subset of colors.

5. The method of claim 4 further comprising providing subset identification, color, and sparkle data to the processor.

6. The method of claim 5 further comprising clustering in the processor, the colors within the subset.

7. The method of claim 6 further comprising determining in the processor if the clusters are assigned to one of a chromatic group and a neutral group.

8. The method of claim 7 further comprising sequencing the clusters by lightness when the group is neutral.

9. The method of claim 8 further comprising sequencing the clusters by hue when the group is chromatic.

10. The method of claim 9 further comprising selecting a single cluster.

11. The method of claim 10 further comprising retrieving the cluster identification, color, and sparkle data.

12. The method of claim 11 further comprising sequencing the colors within the single cluster.

13. The method of claim 11 further comprising re-clustering the single cluster to form sub-clusters.

14. The method of claim 13 further comprising sequencing the colors within sub-clusters in the processor using principal component analysis.

15. The method of claim 13 further comprising sequencing colors by their primary color direction.

16. The method of claim 12 further comprising incorporating chips having the sequenced colors into a fan deck.

17. A system for chromatically sorting colors into a fan deck, each fan deck comprised of a plurality of color chips, the system comprising:
a first source of color identifier data;
a second source of color data; and
a processor coupled to the first and second sources and configured to (a) cluster colors within a subset of colors; and (b) order colors within a cluster.

18. The system of claim 17 wherein the processor is further configured to order the clusters by hue or lightness.

19. The system of claim 18 wherein the processor is further configured to select a single cluster and retrieve identification, color, and sparkle data associated with the single cluster.

20. A chromatically sorted fan deck made in accordance with the following steps:
receiving color identifier data and color measurement data, in at least one illumination and viewing geometry, for a set of colors to be sorted into the fan decks;
determining which of a solid, effect or tri-coat subset each color falls into;
clustering in a processor the colors within each subset;
determining in the processor if the subset is chromatic or neutral;
ordering, in the processor, the cluster by hue if chromatic and by lightness if neutral;
selecting a single cluster, and
sequencing the colors within the single cluster with the processor.
